(19) United States
(12) Patent Application Publication
(10) Pub. No.: US 2016/0157439 A1
(43) Pub. Date: Jun. 9, 2016

(54) PLANT AND GARDEN GROWING SYSTEM

(71) Applicants: Michael Greene, Mendocino, CA (US); Michelle Greene Johnson, Mendocino, CA (US); Mark Greene, Willits, CA (US); Aaron Greene, Willits, CA (US); Mark Carey, Upper Sandusky, OH (US)

(72) Inventors: Michael Greene, Mendocino, CA (US); Michelle Greene Johnson, Mendocino, CA (US); Mark Greene, Willits, CA (US); Aaron Greene, Willits, CA (US); Mark Carey, Upper Sandusky, OH (US)

(73) Assignee: THE PLASTICS GROUP, INC., Willowbrook, IL (US)

(21) Appl. No.: 14/564,970

(22) Filed: Dec. 9, 2014

(51) Int. Cl. A01G 9/14; A01G 9/24; A01G 9/20

(52) U.S. Cl. CPC A01G 9/14; A01G 9/20; A01G 9/24

(57) ABSTRACT

A plant growing system is provided and includes a liquid supply/drain floor system including a first liquid holding tank and a second liquid holding tank adjacent and attached to the first liquid holding tank, a framed structure assembly attached to the first liquid holding tank and the second liquid holding tank, a lighting system attached to the framed structure assembly, and a cover that covers the framed structure. The first liquid holding tank and the second liquid holding tank also function as a floor of the plant growing system.

The innovation disclosed herein relates to an indoor/outdoor growing system and more specifically, to a light and temperature controlled indoor/outdoor greenhouse.

### BACKGROUND

With the garden industry experiencing a boom with more products geared towards growing herbs and vegetables at home and with the market place placing more and more focus on sustainability, a desire to grow plants and/or gardens at home has increased. In addition, the concept of farm-to-table was also becoming more main stream and more restaurants were more inclined to grow their own ingredients.

Consumers, however, who desire to grow plants and/or gardens (hereinafter collectively “vegetation”) are limited to growing the vegetation either outdoors under unpredictable weather conditions or indoors where providing the proper environmental conditions (e.g., light, temperature, humidity, irrigation, etc.) is difficult without the proper means to achieve an optimal growing environment. In addition, planting and growing gardens is seasonal, thus, further limiting the opportunity for consumers to grow their own vegetables.

Conventional commercial greenhouses do not lend themselves to consumer use (even on a smaller scale) as they include a steel framework that is usually covered with a transparent material such as glass to trap light and are not conducive to indoor use.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation a plant growing system is disclosed and include a liquid supply/drain floor system including a first liquid holding tank and a second liquid holding tank adjacent and attached to the first liquid holding tank, a framed structure assembly attached to the first liquid holding tank and the second liquid holding tank, a lighting system attached to the framed structure assembly, and a cover that covers the framed structure, wherein the first liquid holding tank and the second liquid holding tank also function as a floor of the plant growing system.

In another aspect of the innovation a greenhouse is disclosed and includes a floor including a liquid supply tank having a liquid circulating system that circulates liquid throughout the greenhouse and a waste liquid holding tank adjacent and attached to the liquid supply tank, the waste liquid holding tank having a drain assembly that receives waste liquid from the liquid circulating system. The greenhouse further includes a plurality of interconnected modular components forming a frame and a roof structure and being attached to the floor, a vertically adjustable horizontal lighting assembly attached to the roof structure, and a cover that covers the frame and the roof structure.

In still yet another aspect of the innovation an indoor plant growing system is disclosed and includes a liquid supply tank having a liquid circulating system therewith, a waste liquid holding tank adjacent and attached to the liquid supply tanks and including a drain assembly therewith, a framed structure assembly attached to the liquid supply tank and the waste liquid holding tank, a vertical lighting system attached to each corner of the framed structure assembly, a ventilation system attached to at least one side of the framed structure, and a cover that covers the framed structure, the cover having a reflective interior surface that reflects light back toward an interior of the greenhouse

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a top right front perspective view of an innovative indoor plant and garden growing system in accordance with the innovation.

FIG. 2 is a top right front perspective view of the frame structure of the innovative indoor plant and garden growing system in accordance with the innovation.

FIG. 3 is a close up view of a floor of the framed structure having integrated supply and waste tanks in accordance with an aspect of the innovation.

FIG. 3A is a right side view of the framed structure illustrating a location of electric controls, a display, and ventilation fans in accordance with an aspect of the innovation.

FIG. 4 is a close up view of the water supply manifold attached to a pump in accordance with an aspect of the innovation.

FIG. 5 is a close up view of the water supply manifold in accordance with an aspect of the innovation.

FIG. 6 is a close up view of a water supply manifold and water drains installed in the floor of the framed structure in accordance with an aspect of the innovation.

FIG. 6A is a view inside the system illustration placement of drip lines in accordance with an aspect of the innovation.

FIG. 7 is a close up view of the water drain attached to a pump in accordance with an aspect of the innovation.

FIG. 8 is a close up view of a supply/drain spout and level gauge for the integrated supply and waste tanks in accordance with an aspect of the innovation.

FIG. 9 is a top right front perspective view of the frame structure of the innovative indoor plant and garden growing system in accordance with the innovation.

FIG. 10 is a bottom right front perspective view of the frame structure of the innovative indoor plant and garden growing system in accordance with the innovation.

FIG. 10A is a block diagram illustrating the components of a lighting system in accordance with an aspect of the innovation.

FIGS. 11 and 11A are illustrations of an alternative embodiment of a vertical light assembly in accordance with an aspect of the innovation.

FIG. 12 is a close up view of a crank handle to adjust a vertical height of a lighting system in accordance with an aspect of the innovation.

FIG. 13 is a close up view of the electric controls, display, and ventilation fans in accordance with an aspect of the innovation.

FIGS. 14 and 15 are close up views of the electric controls in accordance with an aspect of the innovation.

FIG. 16 is a right rear perspective view of the innovative indoor plant and garden growing system in accordance with the innovation.

FIG. 17 is a left rear perspective view of the innovative indoor plant and garden growing system showing a cover transparent in accordance with the innovation.

FIG. 18 is a perspective view of the innovative indoor plant and garden growing system illustrating a reflective material in accordance with the innovation.

FIG. 19 is a perspective view of the innovative indoor plant and garden growing system illustrating a location of adjustable socks having an adjustable draw cord in accordance with the innovation.

FIG. 20 is a bottom right rear perspective view of the innovative indoor plant and garden growing system in accordance with the innovation.

FIGS. 21 and 22 are close up views of a cover for the electrical controls in accordance with the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

Based on the above mentioned issues, a need exists for a simple protective structure for plants and/or gardens that can be easily modified and regulated to control environmental conditions inside the structure and that can be used outdoors or indoors. Thus, disclosed herein is a plant and garden growing system (e.g., greenhouse) that includes a framed structure enclosed with a shroud or cover and electric controls to control light, temperature, humidity, fertilization, watering, waste water collection and disposal, etc. The system is a self-contained greenhouse for indoor or outdoor use that provides for year round sustainable living for plant maintenance and care.

It is to be understood, that the system can be used in other applications and is not limited to a plant and garden growing system. For example, the structure has a modular design and can be made into different sizes, thus, allowing it to be used for the growth of fungus (e.g., mushrooms), a shelter for animal living including reptiles and birds, a thermal shelter for outdoor activities, such as ice fishing, etc.

The framed structure may be made via a blow-molding process and can be made up of modular pieces including supply and waste tanks integrated into the floor. In addition, the modular pieces may include a simple male/female push/pull locking system that connect the pieces together. Thus, forming a large interior volume structure while minimizing the number of members while maximizing structure strength and stiffness. The framed structure plastic material provides a very good moisture and chemical resistance from fertilizer and other plant nutrients resistance unlike metal structures.

A flexible fabric, light blocking shroud is included that covers the framed structure and provides some “torsion and tensile/compressive” strength and stiffening. The shroud has a Mylar interior that provides light energy management both outside the structure for efficiency and inside the structure for adjusting growing cycles. Thus, the user can take advantage of nighttime energy rates to turn the interior of the greenhouse into daytime. The shroud may include access ports for airflow, user interface, and other plant growth and monitoring functions without additional structural requirements of the unit's design.

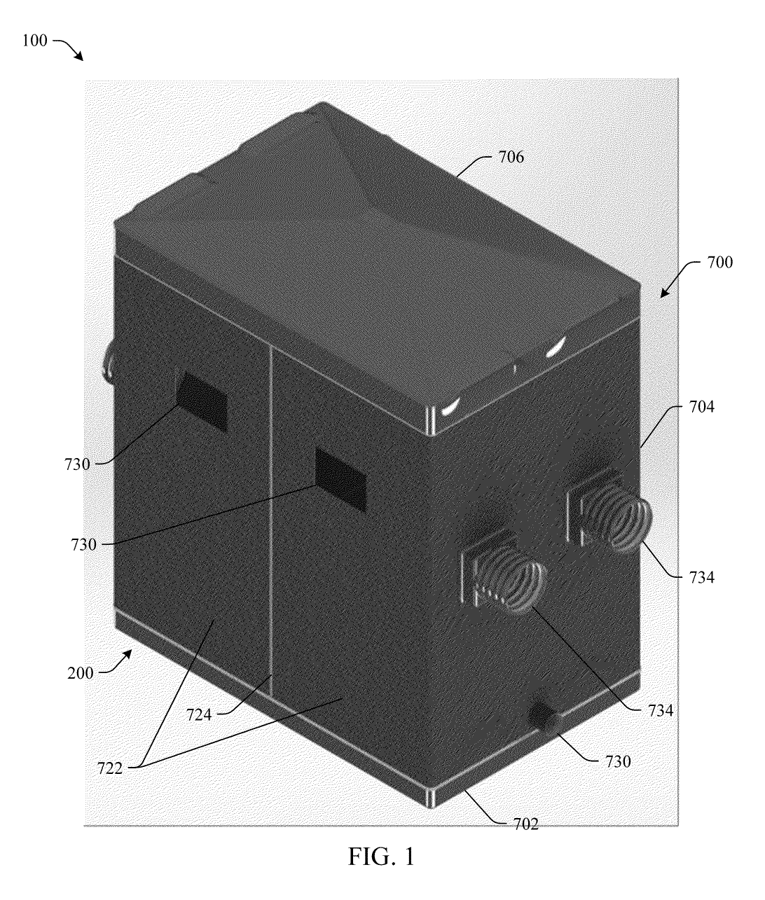

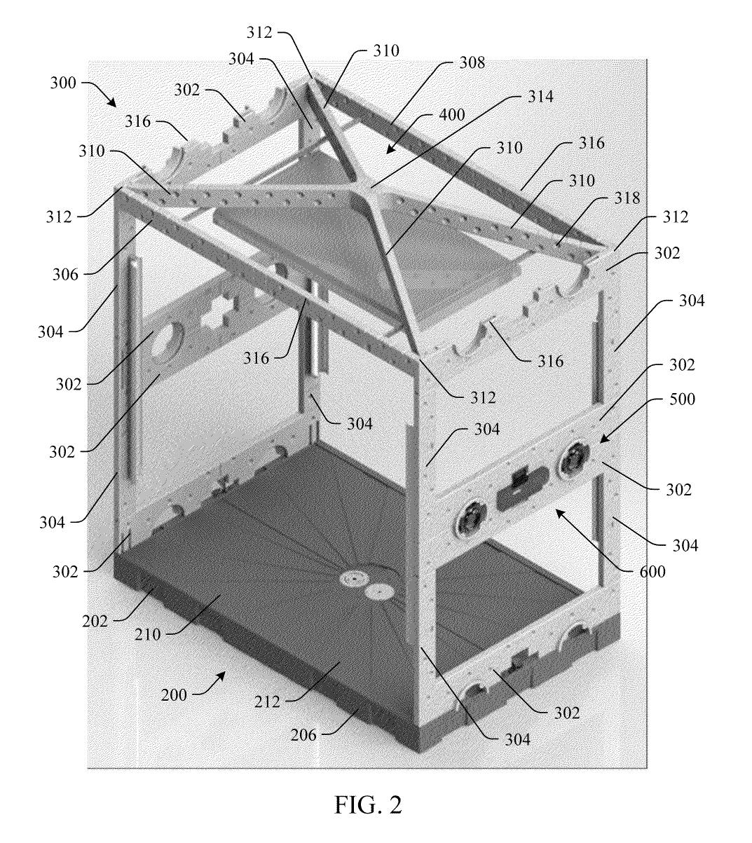

With reference now to the figures, FIG. 1 is a perspective view taken from a top right front of an innovative garden and plant growing system 100 (hereinafter “plant growing system 100”) including the external cover and FIG. 2 is a perspective view taken from the top right front of the garden and plant growing system 100 excluding the external cover in accordance with an aspect of the innovation. The growing system 100 includes, an integrated liquid supply/drain floor system 200 (hereinafter “floor system 200”), a framed structure assembly 300 that resides on the floor system 200, a lighting system 400, a ventilation system 500, an electrical system 600, and a shroud or cover 700 that encloses the growing system 100.

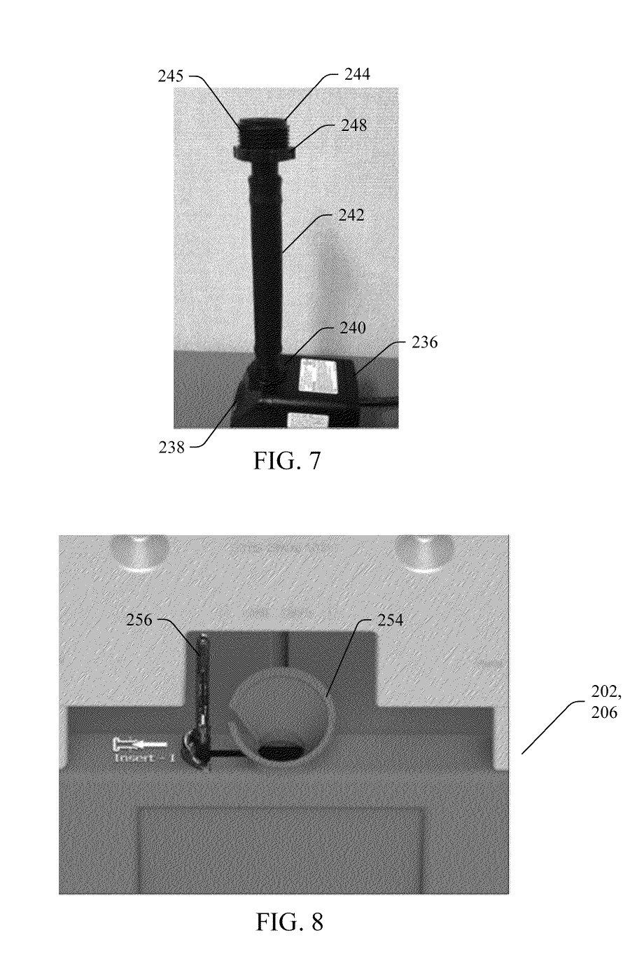

Referring to FIGS. 2-8, the floor system 200 is comprised of two holding tanks, a liquid supply (first) tank 202 including an integrated liquid (e.g., water, fertilizer, chemicals, etc.) circulating assembly 204 and a waste (gray) liquid (second) tank 206 including a drain assembly 208. Thus, as illustrated in the figures, the liquid supply tank 202 and the waste liquid tank 206 not only serve as liquid holding tanks, but also as a top surface 210 of the liquid supply tank 202 and a top surface 212 of the waste liquid tank 206 also serve as a floor of the growing system 100. The holding tanks 202, 206 are separate pieces made from a rigid material (e.g., plastic) that may be manufactured via a blow-molding process, an injection-molded process, etc. and are then joined to form the floor. Elevated ribs 214 are formed on the top surface 210, 212 of each holding tank 202, 206. Drainage paths 216 are formed between each rib 214 to facilitate drainage of liquid to the drain assembly 208.

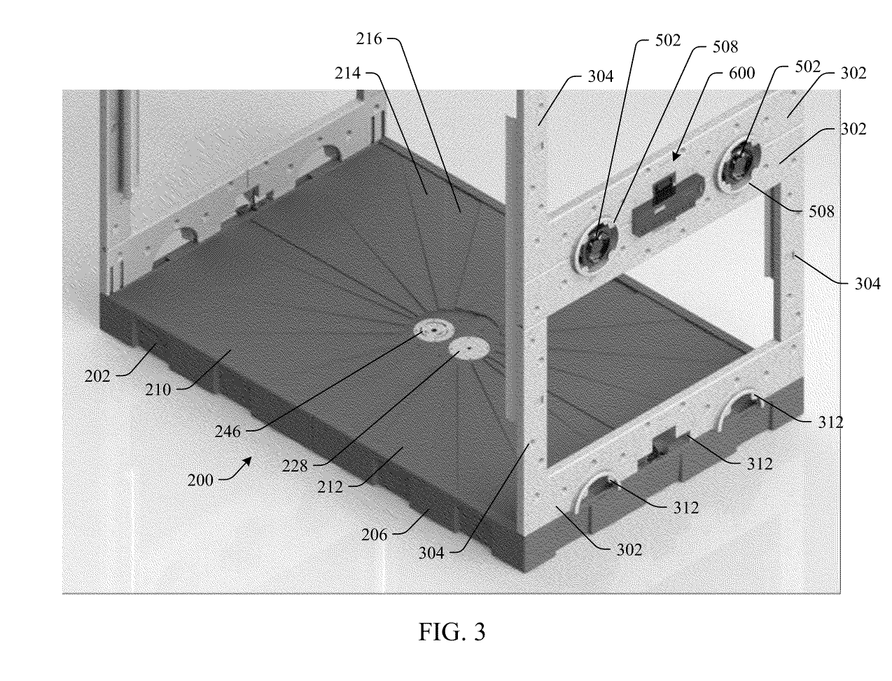

Referring to FIGS. 3-6 and 6A, the liquid circulating system 204 is comprised of a first (circulating) pump 218, a liquid distribution head (or manifold) 220 having multiple liquid discharge ports 222, and multiple liquid drip lines (tubes) 224 that extend from the liquid distribution head 220 to areas within the growing system 100 thereby providing liquid to plants within the growing system 100.

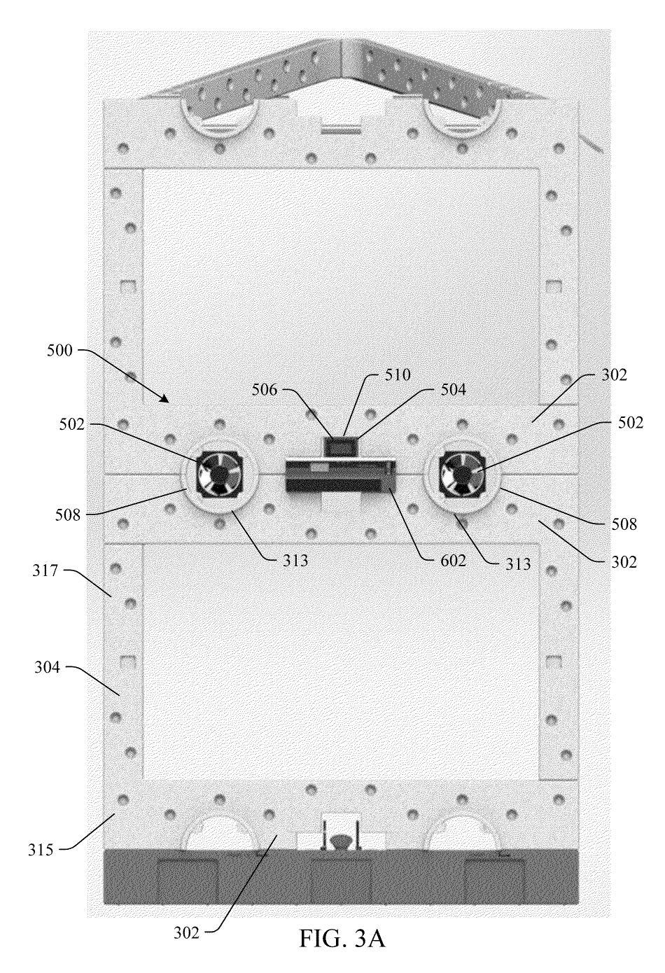

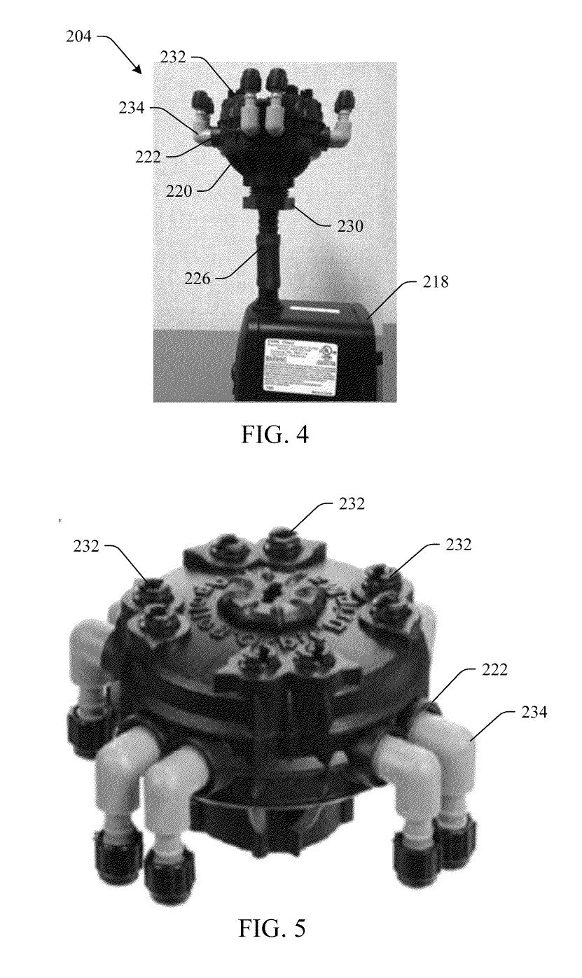

The pump 218 is disposed inside the liquid supply tank 202 and thereby supplies liquid to the liquid distribution head 220 via a supply connecting tube 226, as shown in FIG. 4. The pump 218 supplies the liquid to the contents inside the growing system 100 with minimum changing head pressure thereby providing a more consistent liquid delivery rate of adjustment. The connecting tube 226 extends through the top surface 210 of the liquid supply tank 202 and through a plate 228 made from a water resistant material, such as but not limited to stainless steel, plastic, etc. A fastener 230 threads to a top of the connecting tube 226 below the plate 228 and below the floor surface 210, and the liquid distribution head 220 threads to the top of the connecting tube 226 above the plate 228 and resides on the top surface 210 of the liquid supply tank 202. The fastener 230 tightens against a bottom surface of the floor 210 and the liquid distribution head 220 tightens against the plate 228 thereby securing the pump 218, connecting tube 226, and the liquid distribution head 220 in place.

In the example embodiment illustrated in the figures, the liquid distribution head 220 has eight liquid discharge ports 222. It is to be understood, however, that the innovation is not dependent on the number of liquid discharge ports. Thus, the liquid distribution head 220 illustrated in the figures is for illustrative purposes only and is not intended to limit the scope of the innovation. Independent adjustable regulators 232 are included to regulate a flow rate of the liquid. Each regulator 232 operates independently of the other regulators 232. Thus, the flow rate of liquid from each liquid discharge port 222 can be adjusted and regulated independently to provide an optimal amount of liquid to the desired plants. Fluid connectors 234 provide a connection between the liquid discharge ports 222 and the drip lines 224.

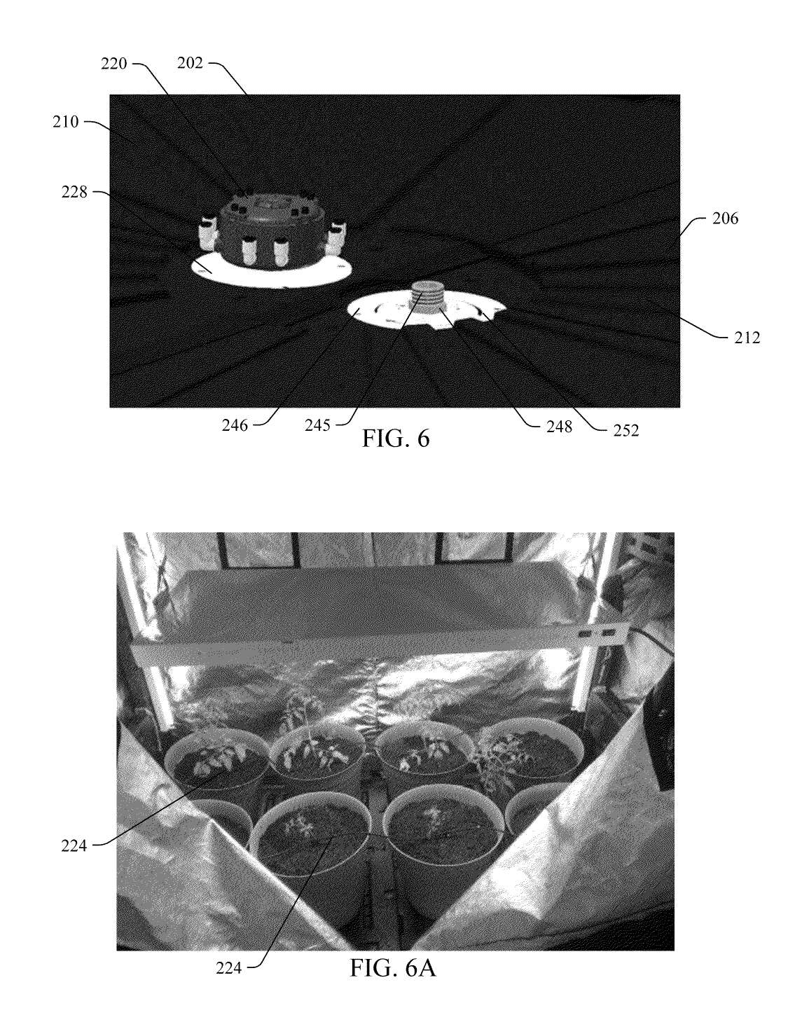

As mentioned above and as shown in FIG. 6, the multiple liquid drip lines (tubes) 224 extend from the liquid distribution head 220 to areas within the growing system 100 thereby providing liquid to plants within the growing system 100. The drip lines 224 may be made from any flexible material capable of transporting a liquid, such as but not limited to rubber, etc. In an alternate embodiment, the multiple drip lines 224 can attach directly to the pump 218. Thus, the pump 218 can include multiple discharge ports and regulators to control the flow rate of the liquid. As such, the liquid distribution head (or manifold) 220 described above is not required and is for illustrative purposes only and is not intended to limit the scope of the innovation.

Referring to FIGS. 3 and 6-7, the drain assembly 208 includes an integrated drain pump 236 that has an inlet port 238 and an outlet port 240, and an outlet port tube 242. Integration of the drain assembly 208 into the waste liquid tank 206 provides the minimum additional draw and head pressure needed to lift the discharge water into a local disposal drain.

The outlet port tube 242 includes a top portion 244 having a fastening mechanism 245 that extends through the top surface 212 of the waste liquid tank 206 and through a plate 246 made from a water resistant material, such as but not limited to stainless steel, plastic, etc. A fastener 248 attaches to the fastening mechanism 245 of the top portion 244 of the outlet port tube 242 below the plate 246 and below the floor surface 212 and tightens against a bottom surface of the floor surface 212 to secure the pump 236 and the outlet port tube 242 in place. The plate 246 includes multiple apertures or openings 252 defined therein to facilitate drainage of the liquid into the waste liquid tank 206.

The drain pump 236 pumps waste liquid out of the waste liquid tank 206 so that the liquid can be disposed externally. Specifically, the pump 236 pulls liquid in through the inlet drain 238, out through the outlet port 240, through the outlet port tube 242 and out the top portion 244. A hose can be attached to the fastening mechanism 245 of the top portion 244, such that the liquid can be pumped out from inside the waste liquid tank 206 and directed outside the plant growing system 100 to an external disposal container and/or facility. The fastening mechanism 245 can be any type of fastener, such as but not limited to, threads for the threading of the hose, a quick disconnect, etc.

The drain pump 236 further includes a power cord. When the user requires usage of the drain pump 236, the user simply plugs the drain pump 236 into one of the continuous ‘on’ outlets in a controller (described further below). It is to be understood that the pump 236 need not be continuously running. The drain pump 236 is used to pump out liquid from inside the waste liquid tank 206 when the waste liquid tank 206 is near full.

Referring to FIG. 8, each tank 202, 206 includes an integrated liquid filler/drain port 254 and a liquid float indicator 256 adjacent to the liquid filler/drain port 254. The filler/drain ports 254 include caps to close-off the ports 254 when not in use. The liquid float indicator 256 simply pivots from a straight up position, as shown in FIG. 8, to indicate an empty tank condition to a near horizontal position to indicate a full tank condition. This visual alert allows the user to be at some visual distance from the filler/drain port 254 and still be able to tell the amount of liquid in each tank 202, 206.

Referring back to FIGS. 2 and 3, the framed structure 300 is comprised of modular-interconnecting components that include side horizontal members 302 that extend from a front to a rear of the framed structure 300, vertical members 304 extending between the horizontal members 302, front and rear header boards 306, 308, and cross support members 310. The framed structure 300 is made from a rigid material (e.g., plastic) that may be manufactured via a blow-molding process, an injection-molded process, etc. The modular interconnecting components include a wedge (male)/pocket (female) interlocking feature for easy locking and unlocking of components. The modularity facilitates structure expansion and reconfiguration. In addition, the modularity also facilitates the addition or relocation of accessories, such as but not limited to, a control unit, electronic display, fans, lighting, watering components, sound equipment, shelving, etc.

The horizontal members 302 extend horizontally from a front to a rear on each side at a bottom (base), middle and top (side header) of the framed structure 300. It is to be understood, however, that the horizontal members 302 can be disposed at any vertical location on each side of the framed structure 300 and, thus are not limited to the locations illustrated in the example embodiment in the figures. The horizontal members 302 lend itself to the modularity of the framed structure 300. Specifically, the same horizontal member 302 is used at the bottom, the middle and at the top of the framed structure 300. The bottom horizontal member is one member shown in a first position and the top horizontal member is also one member shown in an inverted or second position. The middle horizontal member includes two members, one in a first position and one in a second position and are joined to form the middle horizontal member.

The horizontal members 302 include cutouts 312 defined therein to facilitate the mounting of accessories, such as but not limited to, a control unit, electronic display, fans, etc. as will be described further below. The cutouts 312 may be semi-circular, square, rectangular, etc. Thus, when two horizontal members 302 are joined, such as the middle horizontal member, the cutouts 312 form a circle or other shape to facilitate the mounting of an accessory mentioned above. A flange 313 (shown in FIG. 3A) is formed on an outer perimeter of the cutouts 312, thus, forming a circular flange 313 around the joining of two cutouts 312. The flange 313 facilitates a tight fit for sleeves or socks on the cover 700 to minimize air losses.

The vertical members 304 extend vertically between the horizontal members 302 at each corner of the framed structure 300. The vertical members 304 also lend themselves to the modularity of the framed structure 300 in that the same vertical member can be used at each location on the framed structure 300.

In an alternative embodiment illustrated in FIG. 3A, a horizontal member 302 and a vertical member 304 may be joined at a corner 315 to form an integrated L-shaped modular unit 317. As illustrated in FIG. 3A, the L-shaped unit 317 can be inverted and stacked to form each side of the framed structure 300. Since two components are formed in one manufacturing step, this embodiment reduces manufacturing steps and the amount of waste produced, which reduces manufacturing costs. This embodiment also requires fewer modular components and less assembly time, thus, saving costs.

Referring back to FIGS. 2 and 3, the cross support members 310 are angled upward from each corner 312 of the framed structure 300 toward a center 314 and are joined at the center 314 to thereby form a four sided roof that slopes from the center 314 downward toward outside edges 316 thereby forming a parabolic shape. The parabolic shape optimizes the light energy produced by the lighting system 400, as will be described further below during discussion about the shroud or cover 700. In addition, the arched parabolic shape increase the strength of the framed structure 300 and facilitates water runoff thereby preventing pooling, which may cause leaks. Still further, another advantage of the parabolic shape is that it maximizes an internal useable space of the plant growing system 100. Finally, the parabolic shape has aesthetic features that make it more suitable for residence use.

Apertures or indentations (e.g., notches, recesses, channels, etc.) 318 are defined in one or more of the modular components of the framed structure 300 to facilitate the hanging of hanging plants and other plant supporting systems, such as but not limited to, netting, shelving, hooks, etc.

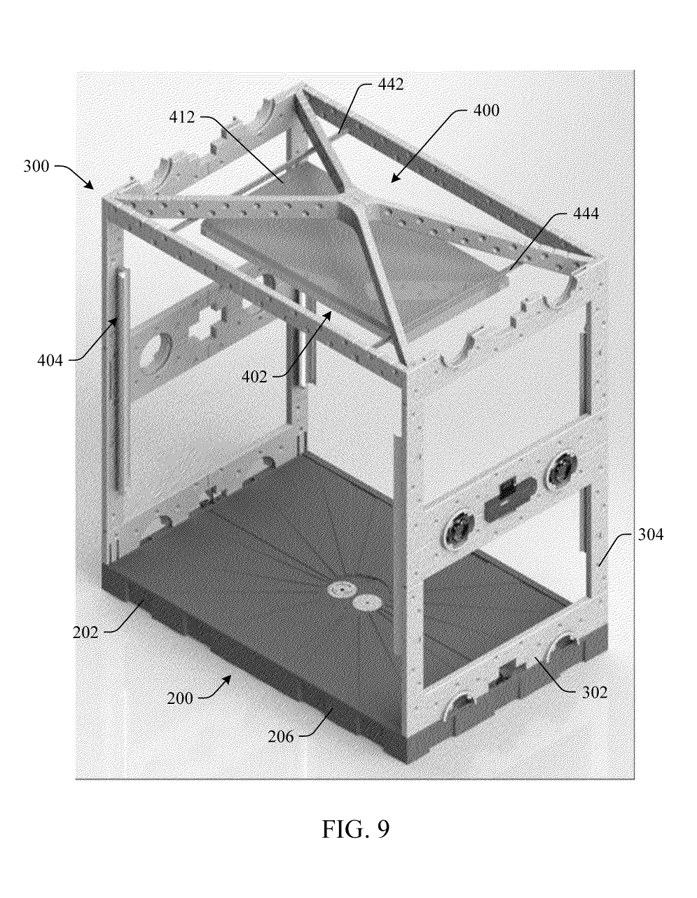

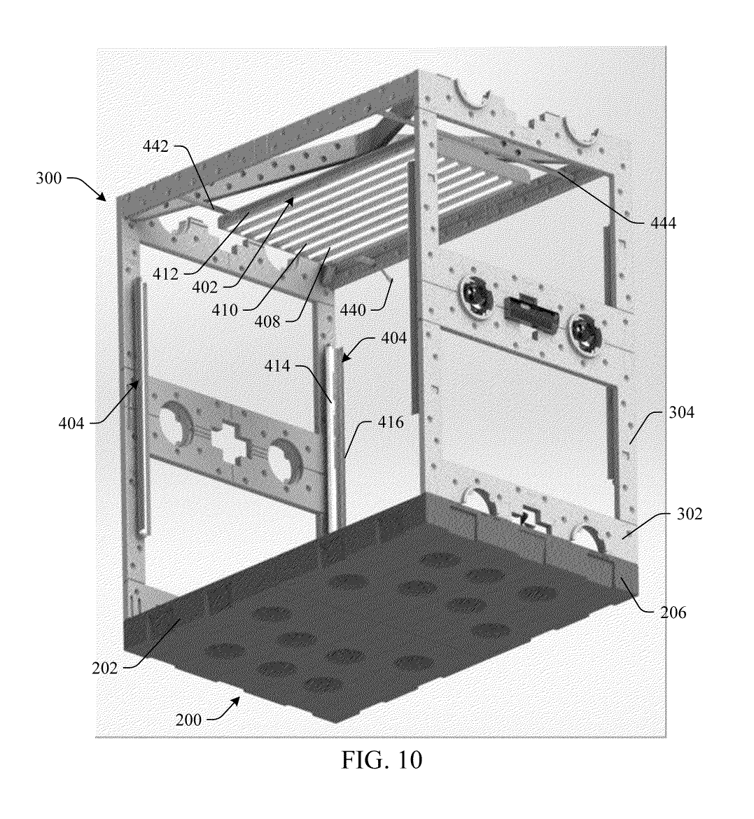

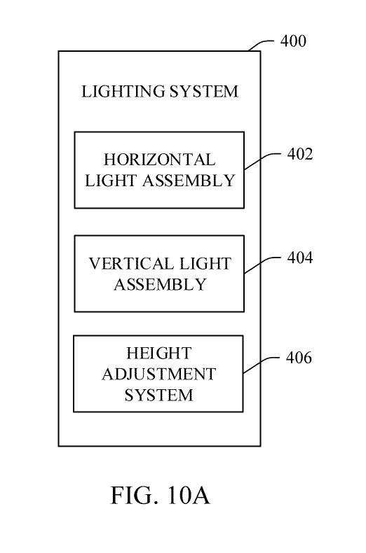

Referring to FIGS. 9 and 10, the lighting system 400 includes a horizontal light assembly 402 and a vertical light assembly 404 disposed at each corner of the framed structure 300. The lighting system 400 is configured to provide optimum lighting inside the plant growing system 100 to thereby facilitate the growth of the plants, vegetation, etc. The lighting system 400 further includes a height adjustment system that vertically adjusts the horizontal light assembly 402 to provide optimum light to the plants during different growing stages.

The horizontal light assembly 402 includes multiple lights 408 adapted to facilitate the growth of plants, vegetation, etc., such as but not limited to, fluorescent lights (e.g., T5, etc.), fluorescent “growing” lights, etc., a reflection assembly 410 and a housing 412 that houses the lights 408 and the reflection assembly 410. The number of lights 408 in a given horizontal light assembly 402 depends on the size of the plant growing system 100. In one embodiment, the reflection assembly 410 includes a single reflector that is disposed inside the housing 412 and extends behind each and every light 408. In another embodiment, the reflection assembly 410 may include multiple reflectors such that a single reflector is disposed behind each light 408. Thus, in this embodiment, the number of reflectors will equal the number of lights 408.

The vertical light assembly 404 includes a vertically mounted light 414 adapted to facilitate the growth of plants, vegetation, etc., such as but not limited to, fluorescent lights, and a reflector 416. The reflector 416 vertically mounts to each corner of the framed structure and more specifically, to the vertical members 304. The vertically mounted light 414, thus, mounts to the reflector 416. The reflector 416 directs the light back toward the center of the plane growing system 100 to thereby optimize the amount of light directed toward the plants. The vertical light assemblies 404 ensures that there are no shadows or regions of reduced light energy within the plant growing systems 100 internal usable space. The vertical light assemblies 404 not only provide additional, multiple directionally “parabolic-ally” focused lighting into the internal useable space, they also act as an integrated structural stiffener and connector. In addition, the vertical light assemblies 404 provide a vertically linear cross-section which allows the use of “sliding track, snap fit” vertically adjustable hooks, which aids in the flexibility of providing plant support and growing system equipment inside the unit.

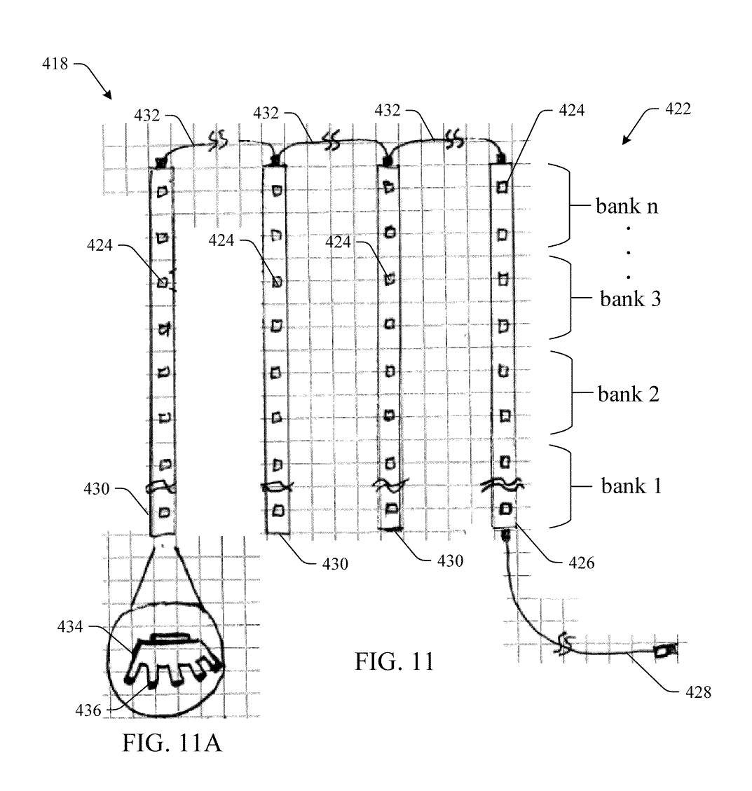

In an alternative embodiment illustrated in FIG. 11, the vertical light assembly 404 may be comprised of a vertically mounted LED light assembly 418 mounted to each corner of the framed structure and more specifically, to the vertical members 304, as above. Each LED light assembly 418 includes multiple LED banks (bank 1, bank 2, bank 3 . . . bank n) 422. Each bank 422 includes multiple LED's 424. The LED light assembly is configured to illuminate the banks 422 from bottom to top (e.g., bank 1 to bank n) as the plants/vegetation grow. In other words, as the plants grow, additional banks 422 are illuminated thereby minimizing energy consumption. The LED's provide a direct focus pattern to further minimize light energy consumption.

The LED light assembly 418 is configured to include a master LED light assembly 426 that includes a power cord 428 and multiple slave LED light assemblies 430. The master and slave LED assemblies 426, 430 are daisy chained together with connecting power cords 432. Thus, as each bank 422 on the master light assembly 426 illuminates, a corresponding bank 422 on the slave light LED light assemblies 430 illuminates.

Referring to FIGS. 11 and 11A, the LED light assemblies 418 are mounted on an extruded base 434 made from a material, such as but not limited to aluminum. The extruded base 434 has a tooth like cross-section shape 436. The tooth like shape 436 acts as a heat sink to pull heat away from the LED light assemblies 418. In addition, the extruded base 434 in combination with the tooth like shape 436 also acts as a stiffener to strengthen the framed structure 300.

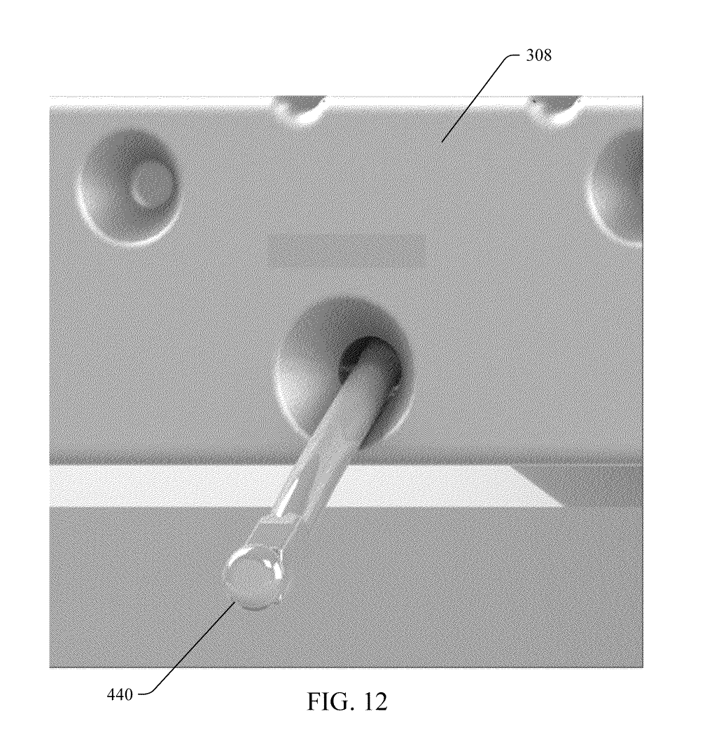

Referring to FIGS. 9, 10, and 10A, the height adjustment system 406 is configured to vertically raise and lower the horizontal light assembly 402 to better direct the light toward the plants thereby optimizing plant growth. The height adjustment system 406 includes an integrally blow-molded handle 440, as shown in FIG. 12, extending outward from either the front or rear header boards 306, 308. The handle 434 is connected to a first take-up tube 442, which is then connected via pulleys and cable to a second take-up tube 444 and to 404 the horizontal light assembly 402. The handle's 440 torque resistant “adjustment” feature interfaces with a novel Blow Mold integral, simple direct draw molded in detent, which allows the handle to “lock” into this feature during the fixed positioning of the horizontal light assembly 402. This also allows the user to “disengage” the detent and turn the handle either clockwise or counter-clockwise to raise or lower the light and release the handle 440 into the detent (by a pre-loaded spring around the handle 440 and inside the torque pipe) to adjust the vertical position of the horizontal light assembly 402. In this embodiment, the horizontal light assembly 402 is raised and lowered via a manual handle. It is to be understood, that the horizontal light assembly 402 can be raised and lowered a motor and may be remotely controlled.

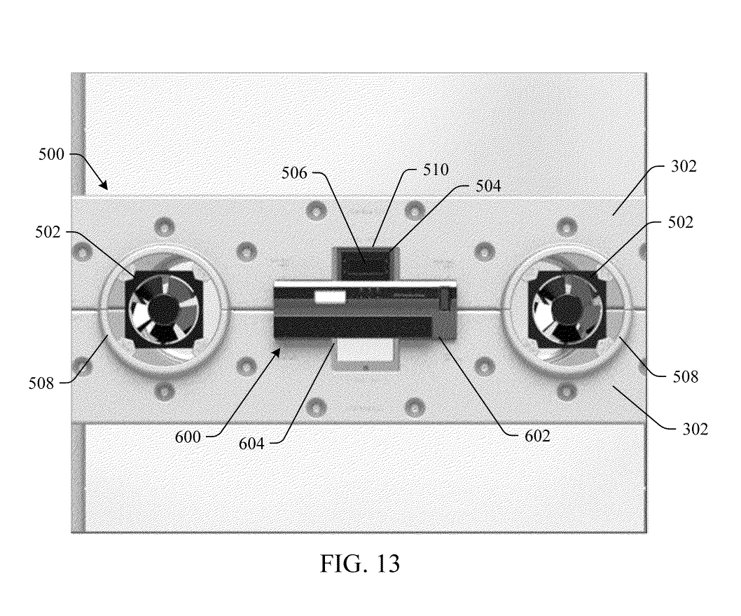

Referring to FIGS. 3, 3A, and 13, the ventilation system 500 includes multiple fans 502 that control airflow horizontally to regulate temperature, humidity, oxygen levels, and carbon dioxide levels for plant health and growth and a programmable thermostat 504 that includes a display 506 and a thermal probe to measure the temperature inside the plant growing system 100. The fans 502 are mounted in a circular cutout 508 formed by two semi-circular cutouts 312 upon the joining of two middle horizontal members 302. The fans 502 may be located on one or both side of the framed structure 300 to produce a stable, uniform horizontal airflow. In one embodiment, in order to conserve energy, the fans 502 run off USB ports on the thermostat 504 via USB cables.

The thermostat 504 is mounted in a rectangular cutout 510 formed in an upper horizontal member 302 and can be programmed with minimum and maximum temperatures inside the plant growing system 100 to thereby automatically control the on/off operation of the fans 502. In another embodiment, a digital controller, described further below, can be programmed to automatically start and stop the fans 502 based on the temperature settings programmed into the thermostat. In still yet another embodiment, one or more fans 502 can be directly plugged into a continuously on USB port in the thermostat 504 or the controller to continuously run the fan 502. This allows the user to continuously control an environmental element (e.g., CO2, humidity, etc.).

Horizontal airflow allows for the minimum energy input, thus, allowing for minimum airflow and fan generated noise levels. In addition, horizontal airflow generates near constant vertical air temperatures. This allows for the most site flexible location installations in the user's home without major concerns over noise levels, even in a bedroom.

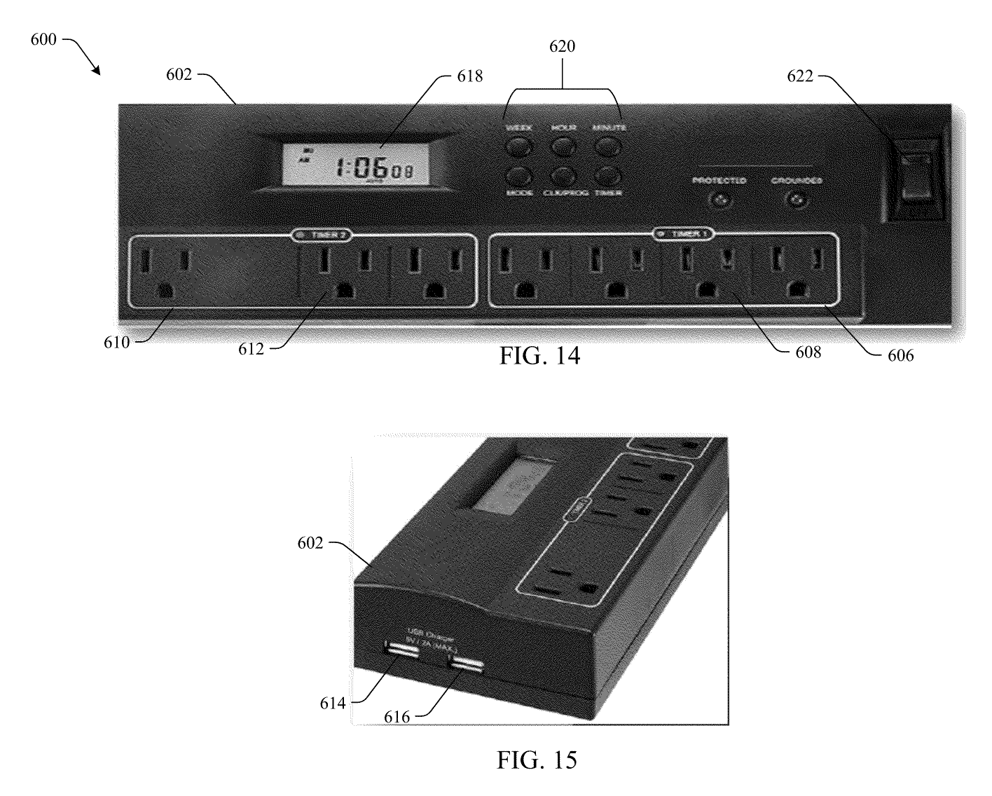

Referring to FIGS. 13-15, the electrical control system 600 includes a controller (electrical panel) 602 that is mounted into a cutout rectangular 604 formed by the joining of two middle horizontal members 302. The controller 602 includes a first timing circuit 606 having multiple outlets 608, a second timing circuit 610 having multiple outlets 612, a first USB port 614, a second USB port 616, a display 618 to display the time and other programming functions, multiple programming buttons 620 to program timing of the liquid circulating assembly 204, the lighting system 400, and the ventilation system 500 (hereinafter collectively “sub-systems 800”), and an on/off switch 622.

For example, any one or all of the sub-systems 800 can be plugged into either the first or second timing circuit 606, 610 or one of the USB ports for the ventilation system 500 and the controller 602 can be programmed to turn any one or all of the sub-systems 800 on and off at pre-determined times on any given day or days during the week to optimize plant growth. In addition, either the first or second timing circuit 606, 610 may include one or more continuous outlets in the event that the user desires to continuously run one or more of the sub-systems 800. Similarly, as mentioned above, the controller 602 may include a continuous ‘on’ USB port so that one of the fans 502 can be directly plugged into the continuously on USB port in the controller 602 to continuously run the fan 502. This allows the user to control an environmental element (CO2, humidity, etc.) continuously.

In alternative embodiments, the controller 602 may be configured to include the following features: 1) Smart Phone WIFI remote access and control; 2) Remote Video monitoring; 3) Direct humidity sensing (both air and soil/growing medium) for monitoring and control adjustment; 4) Computer programmable “auto adjust” features; 5) Control of additional growing equipment including but not limited to; Air Conditioning, CO2 supplementation, other environmental control adjustments, sound or music provisional and control, etc.; 6) Other control features that by using the combination of advanced Wi-Fi monitoring and computer sensing & control, this units basic existing features allow it to be directly upgraded (even in previous models) to the newest, control and sensing packages; 7) Remote access viewing.

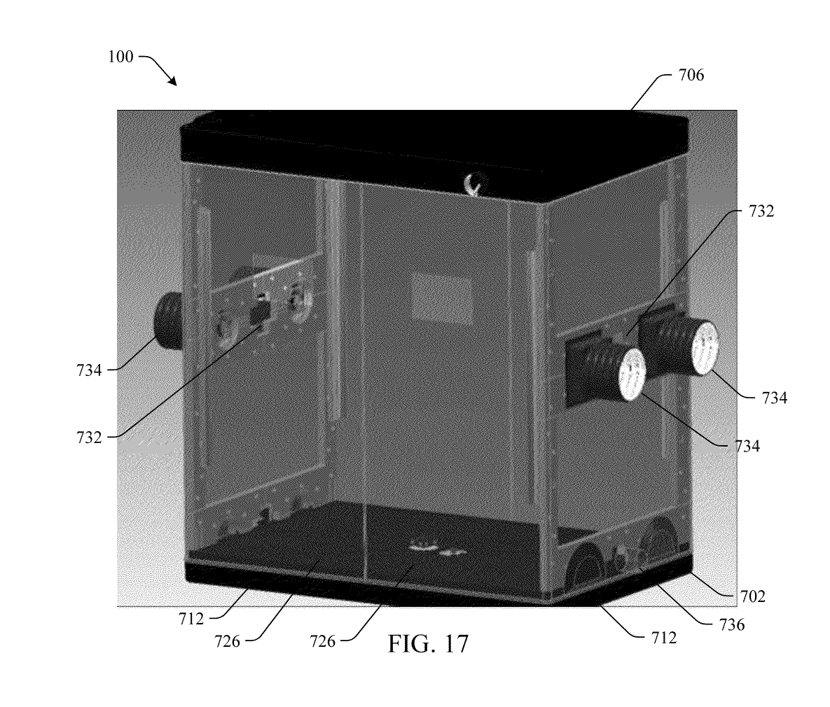

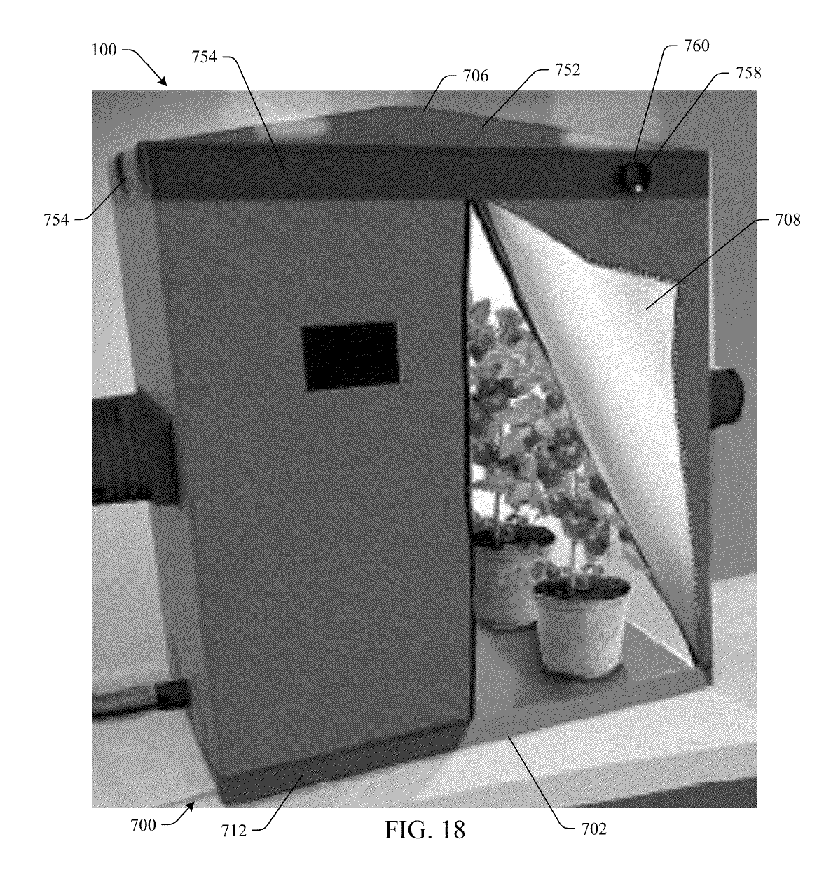

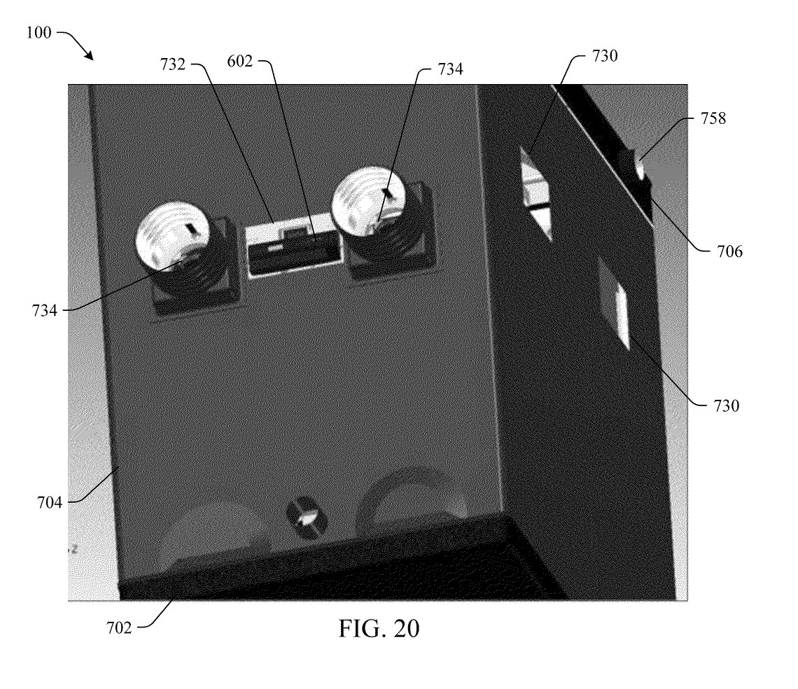

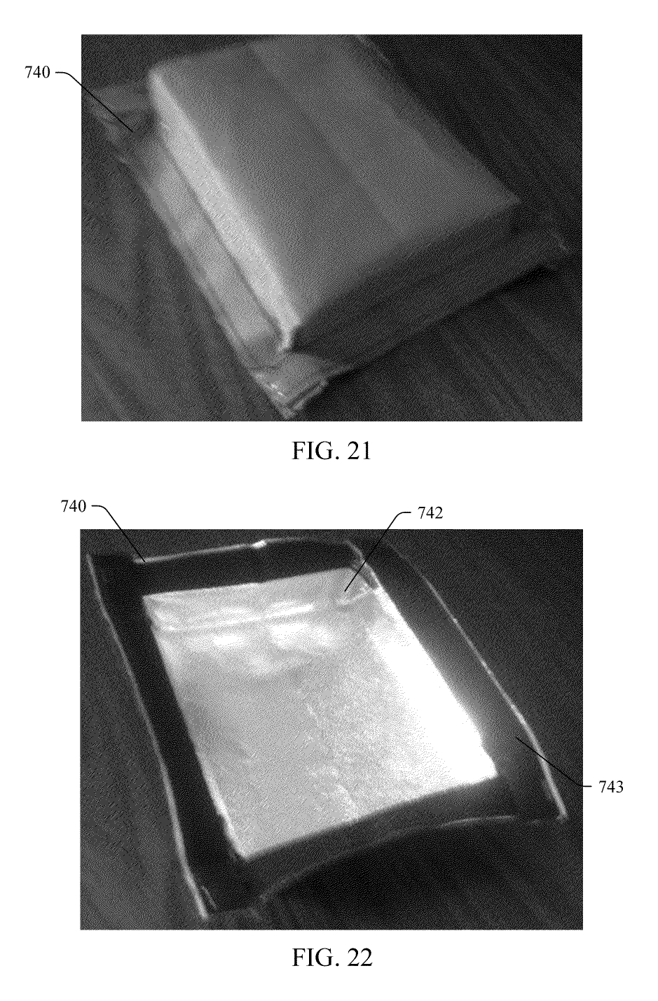

Referring to FIGS. 1 and 16-22, the shroud or cover 700 is a three piece assembly that includes a base section 702, a middle section 704, and a top section 706. The shroud 700 is made from a light blocking canvas or similar material that has a reflective interior surface 708, such as but not limited to Mylar, as shown in FIG. 18. The Mylar interior surface 708 reflects the light emitted from the horizontal and vertical light assemblies 402, 404 back toward an interior of the plant growing system 100 to thereby maximize light energy consumption.

The base section 702 is an integrated piece and includes a bottom 710, four side walls 712, and a fastener 714, such as but not limited to a zipper, Velcro, snaps, etc. that fastens to the middle section 704. The base section 702 is placed underneath the system 100 and more specifically, underneath the holding tanks 202, 206 and the four walls extend upward to approximately the same height as the holding tanks 202, 206. The base section 702 serves as a tray and provides backup liquid leakage protection in the event that condensation or liquid from the liquid circulating assembly 208 does not drain into the drain assembly 208 and overflows from the floor system 200.

The middle section 704 is an integrated piece that includes four sides 720 a first pair (e.g., front) of doors 722 (FIG. 1) having with a fastener 724, such as but not limited to a zipper, Velcro, etc., to open and close the front doors 722, a second pair (e.g., rear) of doors 726 connected with a fastener 728, such as but not limited to a zipper, Velcro, etc., to open and close the rear doors 726. The shroud further includes viewing windows 730, one or more electrical access openings 732 to access the controller 602, multiple ventilation openings 734, and multiple access openings 736 for electrical and/or water hookups. Tie offs are provided on both the front and rear of the shroud 700 to tie back both the first pair and the second pair of doors 722, 726 to allow easy access to the inside of the shroud 700.

The viewing windows 730 comprised a clear membrane may be located on one or more sides 720 of the shroud for viewing the plants inside the shroud 700. Window flaps or removable covers 738 having a reflective inside surface may be provided to cover the viewing windows 730 and may attach to the shroud 700 via a fastener, such as but not limited to hooks, snaps, a zipper, Velcro, etc.

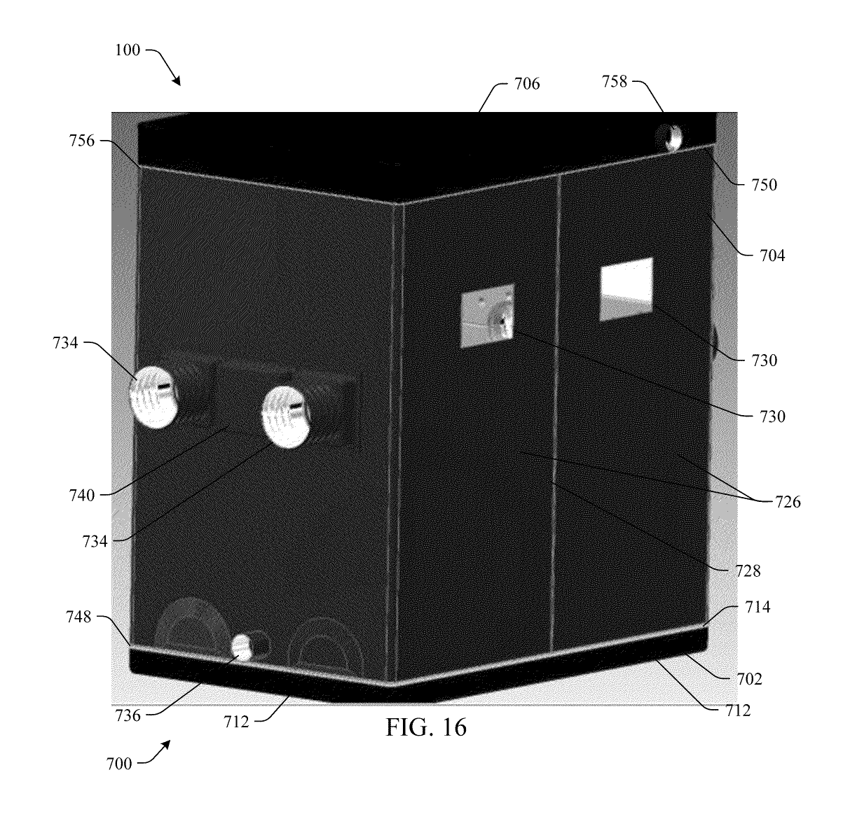

The electrical access opening 732 may be provided on one or both sides of the shroud 700 and is provided to allow access to the controller 602 for programming purposes. As shown in FIGS. 16, 21, and 22, a removable cover 740 having a reflective inside surface 742 may be provided to cover the electrical access openings 732 to protect the controller 602. The cover 740 may be pillowed of approximately 2-5 inches thick to accommodate power cords to be plugged in to the front of the controller 602. The pillowing protects the cords from being accidently struck and becoming damaged or dislodged. The cover 740 may be attached to the shroud 700 via a fastener 743, such as but not limited to hooks, snaps, a zipper, Velcro, etc.

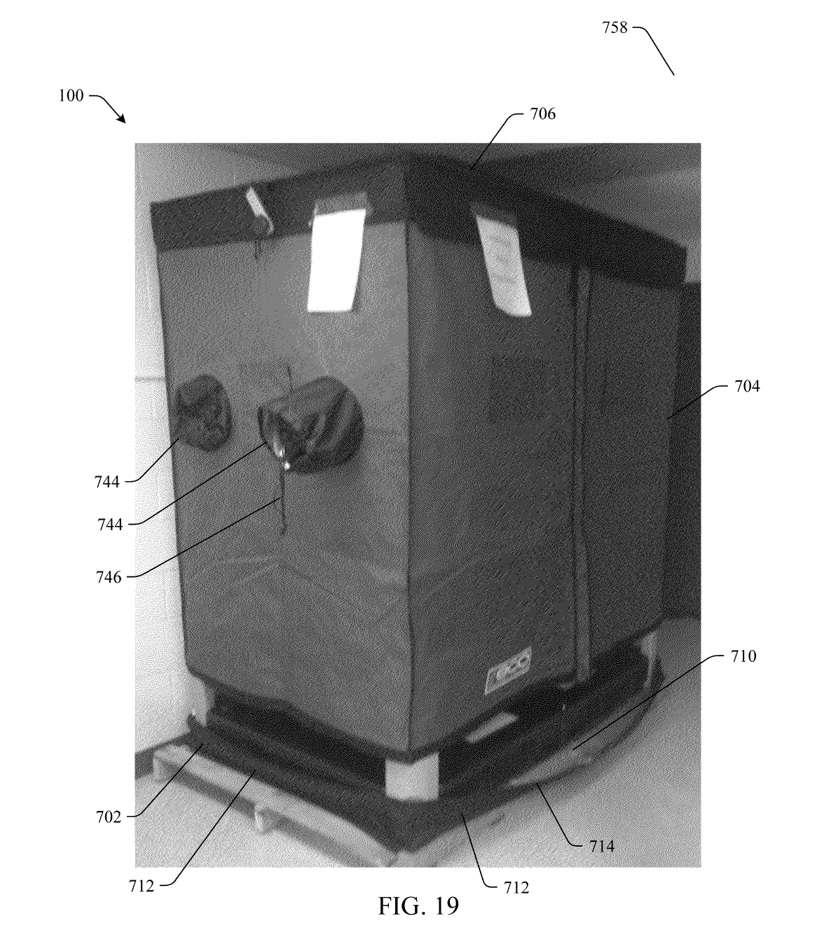

Large adjustable socks 744 are integrated into the shroud 700 and are provided around the multiple ventilation openings 734. The socks 744 include an adjustable draw cord 746 (FIG. 19) to adjust the size or close off the ventilation openings 734 to thereby adjust the ventilation flow through the shroud 700. In addition to the fans 502 disclosed above, the adjustable socks 744 further facilitate the use of other ventilation or air conditioning devices, such as air conditioning units, humidifiers, dehumidifiers, etc.

Smaller adjustable socks 746 are integrated into the shroud 700 and are provided around the multiple access openings 736. The socks 746 include an adjustable tie to adjust the size or close off the access openings 736 to minimize air flow losses.

The shroud 700 may further include integrated internal straps that transfer “torsion stresses” to the shroud 700 thereby providing “diagonal” support without the addition of structural members.

The shroud 700 further includes a first fastener 748, such as but not limited to a zipper, Velcro, snaps, etc., that mates with the fastener 714 on the base section 702 and a second fastener 750, such as but not limited to a zipper, Velcro, snaps, etc., that mates with a fastener on the top section 706.

The top section 706 is an integrated piece and includes a top 752, four side walls 754, and a fastener 756, such as but not limited to a zipper, Velcro, snaps, etc. that fastens to the second fastener 750 on the middle section 704. The top section 706 includes a reflective inside surface (e.g., Mylar) and is placed on top of the framed structure 300 and more specifically, on the cross support members 310. The angle of the cross support members 310 and the addition of the top section 706 creates a parabolic shape that reflects/focuses light back toward the center of the shroud to optimize growing and reduce re-reflected light. The top section 706 further include a handle access opening 758 with an adjustable sock 760 for access to the handle 440 of the height adjustment system 406.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant growing system comprising:
a liquid supply/drain floor system including a first liquid holding tank and a second liquid holding tank adjacent and attached to the first liquid holding tank;
a framed structure assembly attached to the first liquid holding tank and the second liquid holding tank;
a lighting system attached to the framed structure assembly; and
a cover that covers the framed structure,
wherein the first liquid holding tank and the second liquid holding tank also function as a floor of the plant growing system.

2. The plant growing system of claim 1 further comprising a ventilation system that creates a horizontal airflow within the plant growing system.

3. The plant growing system of claim 2 further comprising a controller that controls the operation of the liquid circulating system, the lighting system, and the ventilation system.

4. The plant growing system of claim 1, wherein the liquid supply/drain floor system includes a pump disposed inside the first liquid holding tank and a plurality of drip lines, wherein the pump supplies liquid to the plurality of drip lines for distribution within the plant growing system.

5. The plant growing system of claim 4, wherein the liquid supply/drain floor system further includes a plurality of adjustable regulators that regulate the liquid flow rate through the plurality of drip lines.

6. The plant growing system of claim 5, wherein the liquid supply/drain floor system further includes a liquid distribution head disposed on a top surface of the first liquid holding tank is being connected to the pump via a connecting tube and includes a plurality of liquid discharge ports, and wherein the plurality of drip lines attach to the plurality of discharge ports.

7. The plant growing system of claim 1, wherein the framed structure includes a plurality of modular interconnecting components, wherein at least one of the plurality of modular interconnecting components includes a plurality of cutouts defined therein to receive ventilation and electrical components and wherein notches are defined in the plurality of modular interconnecting components that facilitate the hanging of plants and/or plant growing.

8. The plant growing system of claim 1, wherein the lighting system includes a horizontal light assembly, a vertical light assembly, and a height adjustment system that raises and lowers the horizontal light assembly.

9. The plant growing system of claim 8, wherein the height adjustment system includes a handle, a first take up tube, and a second take up tube, wherein the horizontal light assembly is attached to the first take up tube and tube second take up tube and is raised and lowered via the handle.

10. The plant growing system of claim 1, wherein an interior surface of the cover has a reflective surface that reflects light from the lighting system toward a center of the plant growing system.

11. A greenhouse comprising:
a floor including:
a liquid supply tank having a liquid circulating system that circulates liquid throughout the greenhouse; and
a waste liquid holding tank adjacent and attached to the liquid supply tank, the waste liquid holding tank having a drain assembly that receives waste liquid from the liquid circulating system;
a plurality of interconnected modular components forming a frame and a roof structure and being attached to the floor;
a vertically adjustable horizontal lighting assembly attached to the roof structure; and
a cover that covers the frame and the roof structure.

12. The greenhouse of claim 11 further comprising a vertical light assembly attached the plurality of interconnected modular components at each corner of the frame.

13. The greenhouse of claim 12 further comprising a plurality of fans that creates a horizontal airflow within the greenhouse, wherein the plurality of fans are attached to cutouts defined in horizontal members of the interconnected modular components.

14. The greenhouse of claim 13 further comprising a controller that controls the operation of the liquid circulating system, the vertically adjustable horizontal lighting assembly, the vertical light assembly, and the plurality of fans to optimize plant growth in the greenhouse.

15. The greenhouse of claim 14, wherein the cover includes a base section, a middle section attached to the base section, and a top section attached to the middle section, and wherein an interior surface of the cover has a reflective surface that reflects light from the vertically adjustable horizontal lighting assembly and the vertical light assembly toward a center of the greenhouse.

16. The greenhouse of claim 15, wherein the middle section of the cover includes a plurality of ventilation openings that are aligned with the plurality of fans and facilitate the horizontal airflow created by the plurality of fans.

17. The greenhouse of claim 16, wherein the cover further includes a plurality of socks provided around each of the plurality of ventilation openings and wherein the plurality of socks include an adjustable draw cord that adjusts an opening of each of the plurality of socks thereby adjusting ventilation in the greenhouse.

18. An indoor plant growing system comprising:
a liquid supply tank having a liquid circulating system therewith;
a waste liquid holding tank adjacent and attached to the liquid supply tanks and including a drain assembly therewith;
a framed structure assembly attached to the liquid supply tank and the waste liquid holding tank;
a vertical lighting system attached to each corner of the framed structure assembly;
a ventilation system attached to at least one side of the framed structure; and
a cover that covers the framed structure, the cover having a reflective interior surface that reflects light back toward an interior of the greenhouse

19. The indoor plant growing system of claim 18 further comprising a height adjustable horizontal light assembly attached to a roof of the framed structure.

20. The indoor plant growing system of claim 18, wherein the vertical light assembly includes a plurality of light banks that independently illuminate from a bottom to a top of the vertical light assembly as the growth of the plants inside plant growing system increase and wherein the light banks include a plurality of light emitting diodes (LEDs).
